(19) United States
(12) Patent Application Publication
(10) Pub. No.: US 2002/0121164 A1
(43) Pub. Date: Sep. 5, 2002

(54) Socket wrench

(76) Inventor: Steve Somers, Mundelein, IL (US)

Correspondence Address: Russell E. Hattis, 1640 Jasmine Court, Highland Park, IL, 60035, US

(21) Appl. No.: 10/007,189

(22) Filed: Nov. 8, 2001

Related U.S. Application Data
(60) Provisional application No. 60/253,533, filed on Nov. 28, 2000.

(51) Int. Cl. B25B 23/16

(52) U.S. Cl. 81/177.75

(57) ABSTRACT

A socket wrench is provided which performs the functions heretofore carried out by two separate wrenches. To this end, the present invention provides a wrench where each end thereof selectively acts (a) as a receiving end for a nut or other fastener to be rotated by the wrench and of a different size than that to be received by the other end of the wrench and, (b) as the receiving end of a driver member which is to rotate the wrench to turn the nut or other fastener surrounded by the other end of the wrench. Preferably, the same driver member is insertable into either end of the wrench.

### I. RELATED APPLICATION

This application is based on U.S. Provisional Application Serial No. 60/253,533, filed Nov. 28, 2000.

### II. BACKGROUND AND SUMMARY OF INVENTION

The present invention in its broadest form improves upon the prior art by designing the socket wrenches involved so that instead of a wrench with one socket-forming end and one driver-receiving end as in the prior art, each end of the wrench can perform a double function of selectively acting as a fastener-receiving end for a fastener of a different size or as an end to receive preferably the driving end of the same driver or less desirably for a different sized driver. This feature is used both for wrenches in which the opposite ends are fixed ends or ends which can be pivoted with respect to each other, although the pivoted form shown in the drawings is the preferred form.

### III. DESCRIPTION OF DRAWINGS

FIG. 1 is a side elevational view of a prior art socket wrench and a driver therefor in position to be inserted into the driver-receiving end of the wrench;

FIG. 1A is an end view of the left end of the prior art wrench shown in FIG. 1, as seen in viewing plane 1A-1A thereof, and showing the outer hexagonal bore thereof for receiving the same sized and shaped nut or other fastener to be rotated thereby;

FIG. 1B is an end view of the right end of the prior art wrench shown in FIG. 1, as seen in viewing plane 1B-1B thereof, and showing the outer rectangular bore thereof for receiving the same sized and shaped rectangular end of the driver shown in FIG. 1;

FIG. 2 is a side elevational view of a prior art socket wrench for receiving the driver shown in FIG. 1, but of a size to receive a nut or other fastener of a larger size than the wrench of FIG. 1 can accommodate;

FIG. 2A is an end view of the left end of the prior art wrench shown in FIG. 2, as seen in viewing plane 2A-2A thereof, and showing the outer hexagonal bore for receiving the same sized and shaped nut or other fastener to be rotated thereby;

FIG. 2B is an end view of the right end of the prior art wrench shown in FIG. 2, as seen in viewing plane 2B-2B thereof,and showing the outer rectangular bore thereof for receiving the rectangular end of the driver shown in FIG. 2;

FIG. 3 is a side elevational view of a wrench of the present invention and a driver in position to be inserted into one end of the wrench, where the wrench is uniquely designed to receive at either end thereof the driver there shown, and wherein the opposite ends of the wrench are also respectively designed to receive the nuts or other fasteners of the two sizes which the two prior art wrenches of FIGS. 1 and 2 are needed to rotate the differently sized fasteners involved;

FIG. 3A is an end view of the left end of the wrench of FIG. 3, as seen in viewing plane 3A-3A thereof, and showing an outer hexagonal fastener-receiving bore thereof which is the same size as the hexagonal bore of the prior art wrench of FIG. 2 and a smaller inner rectangular bore thereof for receiving the rectangular end of the driver shown in FIG. 3;

FIG. 3B is an end view of the right end of the wrench of FIG. 3, as seen in viewing plane 3B-3B thereof, and showing the outer hexagonal fastener-receiving bore thereof which is the same size as the smaller hexagonal bore of the prior art wrench of FIG. 1 and a smaller inner rectangular bore thereof for receiving the rectangular end of the driver shown in FIG. 3;

FIG. 3C is a transverse section through the ball-forming portion of the socket wrench shown in FIG. 3, as seen in viewing plane 3C-3C thereof;

FIG. 3D is a sectional view through the end of the driver shown in FIG. 3 taken along section plane 3C-3C and showing the spring urged ball which interlocks with the walls of a hole in the end of the wrench selected to be the driving end thereof;

FIG. 4 is an exploded view of the wrench of the present invention shown in FIG. 3 and showing (a) the left and right socket-forming and driver-receiving parts of the wrench assembly of the invention shown in FIG. 3, and (b) the ball-forming, spring and friction pin parts which interconnect the left and right socket-forming and driver-receiving parts of the wrench assembly, so as to permit the same to be pivoted with respect to each other in the preferred form of the invention; and

FIG. 5 is a perspective view of a tray containing in three storage pockets thereof three socket wrenches of the invention, giving the user a selection of 6 socket sizes the prior art required 6 separate wrenches to accommodate.

### IV. DETAILED DESCRIPTION OF DRAWINGS

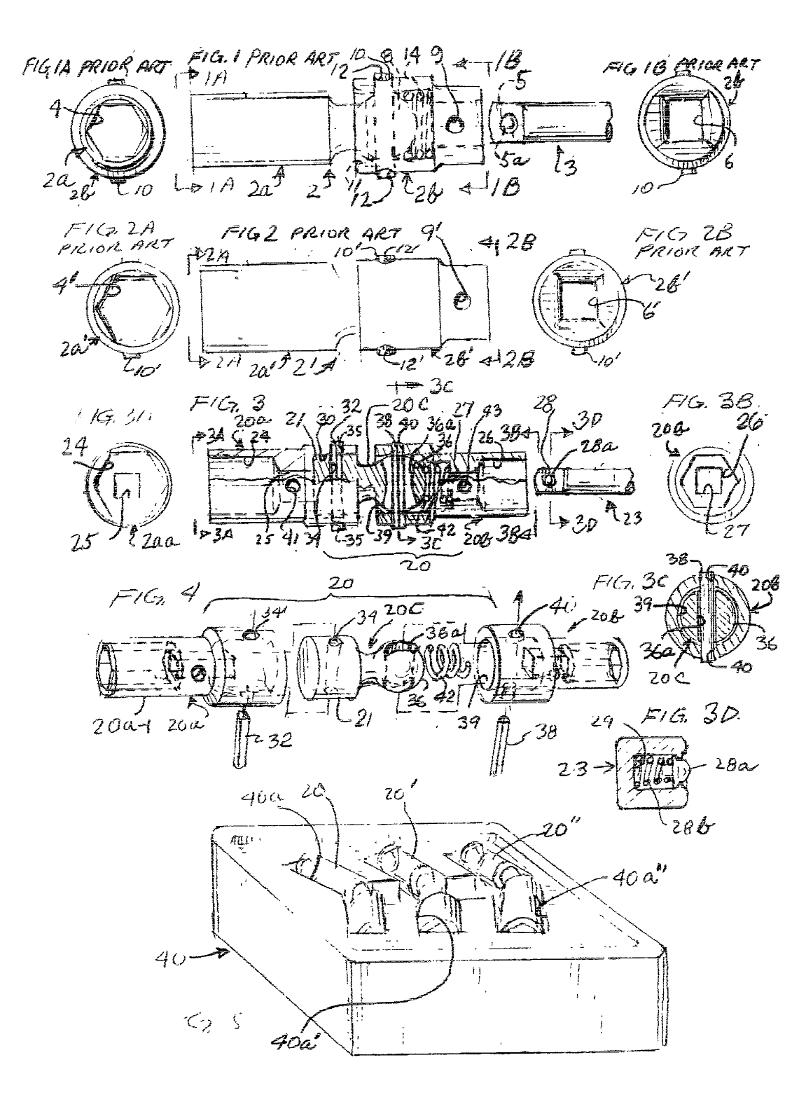

FIGS. 1 and 2 show two prior art socket wrenches 2 and 2′ for only receiving at their left ends as illustrated a nut or other fastener having a hexagonal shape of a different size and for receiving at their right ends a driver member 3. Each socket wrench as illustrated is an assembly comprising (a) a left socket-forming part 2a or 2a′ having a different sized outer hexagonal bore 4 or 4′ opening onto the outer left end thereof for fitting over a nut or other fastener to be rotated thereby and (b) a right driver-receiving part 2b or 2b′ with an identical square bore 6 or 6′ at the right or outer end thereof for receiving the square end of the driver member 3.

The driving end 5 of the driver member 3 has a spring urged ball 5a projecting from the side thereof which when the driving end is fully inserted into the bore 6 or 6′ snaps into an opening 9 or 9′ on the right end of the driver-receiving part 2b or 2b′. The driver-receiving part 2b or 2b′ has at the inner or left end thereof a ball-receiving bore like 11 shown only on part 2b which opens onto the left end thereof to receive a ball-shaped projection 8 shown only on the part 2a extending from the socket-forming part 2a or 2a′. A pin 10 or 10′ extending through aligned openings 12-12 or 12′-12′ in the driver-receiving part 2b or 2b′ and a suitably shaped slot (not shown) in the ball-shaped projection 8 both anchors the assembly parts 2a-2b or 2a′-2b′ together and permits these parts to be pivoted with respect to each other in a manner similar to that used in the invention to be described in detail below. This allows the left socket-receiving parts 2a or 2a′ to be applied over a nut or other fastener where there is insufficient clearance space to receive the driver-receiving part 2b or 2b′ when in perfect axial alignment therewith. A coil spring 14 is interposed between the end of ball S and an inner wall of the part 2b or 2b′.

FIGS. 3 and 4 show the preferred, but not the only, form of the invention. As thee shown, a socket wrench assembly 20 includes left and right main socket-forming and driver-receiving parts 20a-20b interconnected by a preferably separate ball-forming part 20c which permits the socket-forming and driver-receiving parts 20a and 20b to be pivoted with respect to each other. The ball-forming part 20c has a cylindrical end 21 which fits within a similarly sized cylindrical bore 30 at the inner end of the left main assembly part 20a. An anchoring pin 32 is shown passing through aligned lateral openings 35-35 at the inner end of the left main assembly part and a lateral opening 34 in the cylindrical end of the ball-forming part 20c to secure these parts together.

The right hand end of the ball-forming part 20c has a spherical shape to form a ball 36 fitting into a cylindrical bore 39 at the inner end of the right main assembly part 20b. The ball 36 has a slot 36a which in the longitudinal vertical plane shown in FIG. 3 has an hour glass-shape wider at its top and bottom ends, to permit the ball-forming part 20c to be pivoted in this plane relative to the right main assembly part 20b. This slot has a width in the transverse plane shown in FIG. 3C which is about the size of an anchoring pin 38 which passes through aligned top and bottom openings 40-40 in the inner end of the right assembly part 20b and through the hour glass-shaped slot 36a. A coil spring 42 is compressed between the innermost end of the cylindrical bore 39 of the right assembly part 20b and the end of the ball 36 to hold the ball-forming part 20c and the right assembly part 20b in a normal fixed aligned position which can be shifted by pivoting the main assembly parts in the vertical plane referred to. To simplify and minimize the cost of manufacturing the right and left main assembly parts, the cylindrical bores 30 and 39 at the inner ends of the main assembly parts 20a and 20b are identical and the anchoring pin-receiving holes 35-35 and 40-40 are identical in shape and position so that the ball-forming part 20c can be either mounted on the inner end of part 20a or 20b and fit into the inner end of the other part as described.

What makes the present invention novel is that (a) each of the main assembly parts 20a and 20b are formed with differently sized outer non-circular (hexagonal in the example shown) socket-forming bores 24 and 26 (see FIGS. 3A and 3B) to receive correspondingly shaped and sized nuts or other fastening means to be rotated by the wrench assembly 20 and (b) smaller preferably but not necessarily identical non-circular (square in the embodiment shown) driver-receiving bores 25 and 27 located between the outer and inner bores 24-30 and 26-39to receive the rectangular end 28 of the driver member 23 shown in FIG. 3. The driver member can thus be inserted into whatever end of the wrench assembly 20 desired to receive the driver member 23, the other end then forming the desired sized fastener-receiving socket. The right and left assembly parts 20a and 20b have similarly placed holes 41 and 43 communicating with the driver-receiving bores 25 and 27. As shown in FIGS. 3 and 3D, the square shaped end 28 of the driver member 23 has a detent 28a mounted in a recess 29 therein and urged outwardly by a spring 28b so that full insertion of the driving end of the driver member 23 into the outer fastener-receiving end of the left or right part 20a or 20b will cause the detent 28a to snap into the hole 41 or 43 to interlock the driver 23 with the wrench assembly 20 of the invention.

FIG. 5 shows a tray 40 with three pockets 40a, 40b and 40 one holding the wrench assembly 20 just described and the other holding similar wrench assemblies but with difference socket sizes, so that only three such assemblies are needed for 6 different fastener sizes. In contrast, as above indicated, the prior art required six different wrench assemblies for this purpose.

The form of the invention just described is the preferred, most advantageous form of the invention constituting one aspect of the invention which is the subject of some of the claims to follow, other less preferred forms of the invention form broader aspect thereof as exemplified by the more broadly worded claims to follow.

I claim:

1. An assembly of socket wrench-making parts forming or to form a wrench which can be applied over and rotate non-circular nuts or the like of at least two sizes, said parts including:
left and right parts connectable at their inner ends and each part having a differently-sized nut or the like-receiving outer socket or bore opening onto the outer axially facing end thereof;
each said outer socket or bore being sized to receive a differently-sized, correpsondingly shaped and sized nut or the like to be rotated by the wrench;
and each part further having axially inwardly of and axially aligned with and opening onto the inner end of the associated outer socket a non-circular driver member-receiving inner bore of smaller size than the associated outer socket or bore;
wherein a driver member may be inserted through the outer socket of either part and into and drivingly interconnect with the defining walls of said inner bore of either one of said wrench-forming parts, permitting the outer socket or bore of the other part to be applied over the nut or other fastening means involved to be rotated by a rotating force applied to the driver member.

2. The assembly of claim 1 wherein one of said parts has extending from the inner end thereof a fastening means for attaching said one part to the inner end of the other part.

3. The assembly of of claim 2 wherein said fastening means permits one of the parts to be pivoted with respect to the other part in a longitudinal plane.

4. The assembly of claim 1 whewrein said inner bores are of the same size to receive the same driver member.

5. A socket wrench comprising:
a body having opposite ends, each end having a differently-sized nut or the like-receiving outer socketl or bore opening onto the outer end thereof, each said outer socket or bore being sized to receive a differently-sized, correspondingly shaped and sized nut or the like to be rotated by the wrench;
and each opposite end of the wrench further having axially inwardly of and axially aligned with and opening onto the inner end of the associated outer socket a non-circular driver member-receiving inner bore of smaller size than the associated outer socket or bore;
wherein a driver member may be inserted through the outer socket at either end of the wrench and into and drivingly interconnect with the defining walls of said inner bore of either one of said wrench-forming parts, permitting the outer socket or bore of the other part to be applied over the nut or other fastening means involved to be rotated by a rotating force applied to the driver member.

6. The socket wrench of claim 4 where the opposite ends of said wrench body are interconnected by pivot-forming mean permitting one end of said body to be pivoted with respect to the other in a longitudinal plane.

7. The assembly of claim 1 wherein said inner bores are of the same size to receive the same driver member.
